(19) United States
(12) Patent Application Publication
(10) Pub. No.: US 2012/0203524 A1
(43) Pub. Date: Aug. 9, 2012

(54) QUANTITATIVE METHOD OF DETERMINING SAFE STEAM INJECTION PRESSURE FOR ENHANCED OIL RECOVERY OPERATIONS

(75) Inventors: Lee Chin, Houston, TX (US); Michael E. Vienot, Glenview, IL (US)

(73) Assignee: ConocoPhillips Company, Houston, TX (US)

(21) Appl. No.: 13/367,578

(22) Filed: Feb. 7, 2012

Related U.S. Application Data
(60) Provisional application No. 61/441,123, filed on Feb. 9, 2011.

(51) Int. Cl. G06F 17/10; G06G 7/48

(52) U.S. Cl. 703/2

(57) ABSTRACT

This invention relates to a method for determining the safe steam injection pressure for enhanced oil recovery operations.

### CROSS-REFERENCE TO RELATED APPLICATIONS

This application claims priority benefit under 35 U.S.C. Section 119(e) to U.S. Provisional Patent Ser. No. 61/441,123 filed on Feb. 9, 2011 the entire disclosure of which is incorporated herein by reference.

### FIELD OF THE INVENTION

This invention relates to a method for determining the safe steam injection pressure for enhanced oil recovery operations.

### BACKGROUND OF THE INVENTION

Hydrocarbons obtained from subterranean (e.g., sedimentary) formations are often used as energy resources, as feedstocks, and as consumer products. Concern over depletion of available hydrocarbon resources and overall declining quality of produced hydrocarbons have led to the development of processes for more efficient recovery, processing and/or use of available hydrocarbon resources. Steam-assisted gravity drainage (SAGD) processes may be used to remove hydrocarbon materials from subterranean formations. Chemical and/or physical properties of hydrocarbon material within a subterranean formation may need to be changed to allow hydrocarbon material to be more easily removed from the subterranean formation. The chemical and physical changes may include in situ reactions that produce removable fluids, composition changes, solubility changes, density changes, phase change, and/or viscosity changes of the hydrocarbon material within the formation. A fluid may be a gas, a liquid, an emulsion, a slurry, and/or a stream of solid particles that has flow characteristics similar to liquid flow.

With steam injection, reservoir pressure and temperatures are raised. These elevated pressure and temperatures alter the rock stresses sufficiently to cause shear failure within and beyond the growing steam chamber. In general, higher steam injection pressure helps lift fluid from downhole to the surface, increases the oil production rate, reduces the overall well life and improves the ultimate oil recovery. The associated increases in porosity, permeability and water transmissibility accelerate the process. Pressures ahead of the steam change are substantially increased, which promotes future growth of the steam chamber. Some of these enhancements can result from geomechanical effects induced by higher steam chamber pressure. For the unconsolidated oil sands reservoir under certain in situ stress conditions, higher steam injection pressure tends to induce larger volumetric strain associated with shear dilation, thermal expansion, and even, tensile failure. As a result, reservoir permeability can be improved and oil recovery will be accelerated.

Higher steam injection pressure, however, can also have undesirable effects. It can cause the reservoir caprock to be breached due to geomechanical behavior, and then result in a very high steam-oil ratio (SOR).

Therefore, a need exists for a quantitative method for determining optimal safe steam injection pressure during the SAGD process to ensure caprock integrity.

### SUMMARY OF THE INVENTION

In an embodiment, a method for determining the optimal safe injection operating pressure in a subterranean reservoir includes: (a) constructing a reservoir simulation model; (b) constructing a geomechanical model; (c) coupling the reservoir simulation model and the geomechanical model; (d) conducting a plurality of parametric simulation runs utilizing the coupled reservoir simulation and geomechanical models; (e) calculating a maximum equivalent plastic strain for each parametric simulation run; (f) calculating a correlation parameter for each parametric simulation run, wherein the correlation parameter is a relationship between physical parameters of the subterranean reservoir, operating variables of the oil recovery process, and physical coefficients from subterranean reservoir characteristics; (g) plotting the maximum equivalent plastic strain versus the correlation parameter for each parametric simulation run; (h) evaluating the plot of the maximum equivalent plastic strain versus the correction parameter for the plurality of parametric simulation runs from step (g) to determine a critical value, wherein the critical value is an observed value between a grouping of plotted values with zero maximum equivalent plastic strain and a grouping of plotted values with a maximum equivalent plastic strain greater than zero; (i) adjusting the physical coefficients and repeating steps (e)-(h) until a critical value is determined; (j) re-calculating the correlation parameter of the subterranean formation for a given steam injection pressure; and (k) adjusting the given steam injection pressure until the re-calculated correlation parameter is less than the critical value.

In another embodiment, a method for determining the optimal safe injection operating pressure in a subterranean reservoir include: (a) constructing a reservoir simulation model; (b) constructing a geomechanical model; (c) coupling the reservoir simulation model and the geomechanical model; (d) conducting a plurality of parametric simulation runs utilizing the coupled reservoir simulation and geomechanical models; (e) calculating a maximum equivalent plastic strain for each parametric simulation run; (f) calculating a correlation parameter for each parametric simulation run, wherein the correlation parameter is a relationship between physical parameters of the subterranean reservoir, operating variables of a steam assisted gravity drainage process, and physical coefficients from subterranean reservoir characteristics, wherein the correlation parameter is calculated by utilizing the following relationship

$${( \frac{{H}_{p}}{H} + \frac{{H}_{t}}{H} )}^{a} {( \frac{P}{{Z}_{3}} )}^{b} {( \frac{{D}_{1}}{H} )}^{c}$$

in which H=subterranean reservoir thickness, Hₚ=the height of a pressure front, Hₜ=the height of a temperature front, P=a steam injection pressure, Z₃=the depth from the top of the subterranean reservoir, D₁=the distance between the top of the subterranean reservoir and the center of an injection depth, and a, b, c=physical coefficients of the subterranean reservoir; (g) plotting the maximum equivalent plastic strain versus the correlation parameter for each parametric simulation run; (h) evaluating the plot of the maximum equivalent plastic strain versus the correction parameter for the plurality of parametric simulation runs from step (g) to determine a critical value, wherein the critical value is an observed value between a grouping of plotted values with zero maximum equivalent plastic strain and a grouping of plotted values with a maximum equivalent plastic strain greater than zero; (i) adjusting the physical coefficients of the subterranean reservoir and repeating steps (e)-(h) until a critical value is determined; (j) re-calculating the correlation parameter for a given steam injection pressure; and (k) adjusting the given steam injection pressure until the re-calculated correlation parameter is less than the critical value.

### BRIEF DESCRIPTION OF THE DRAWINGS

The invention, together with further advantages thereof, may best be understood by reference to the following description taken in conjunction with the accompanying drawings in which:

FIG. 1 is a flowchart in accordance with an embodiment of the present invention.

### DETAILED DESCRIPTION OF THE INVENTION

Reference will now be made in detail to embodiments of the present invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used in another embodiment to yield a still further embodiment. Thus, it is intended that the present invention cover such modifications and variations that come within the scope of the appended claims and their equivalents.

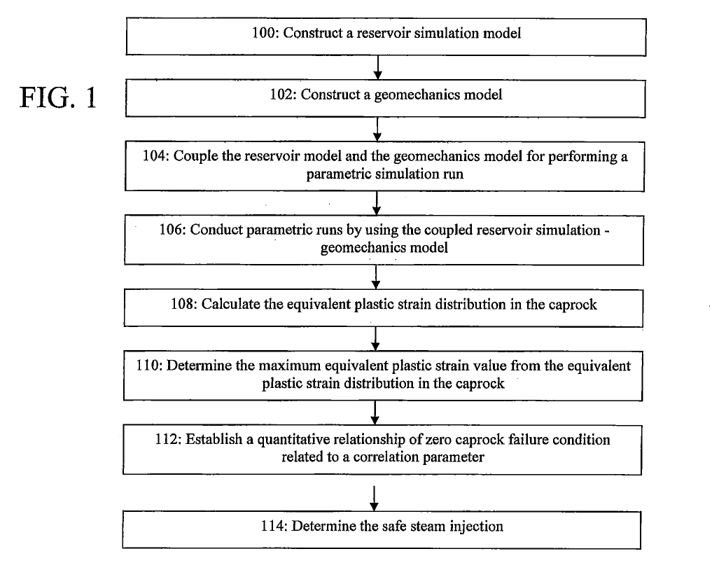

FIG. 1 is a flowchart of an exemplary process for determining the optimal safe steam injection pressure for enhanced oil recovery techniques. Some of the blocks of the flowchart may represent a code segment or other portion of the computer program. In some alternative implementations, the functions noted in the various blocks may occur out of the order depicted in FIG. 1. For example, two blocks shown in succession in FIG. 1 may in fact be executed substantially concurrently, or the blocks may sometimes be executed in the reverse order depending upon the functionality involved.

In step 100, a reservoir simulation model is constructed. The reservoir simulation model is used to predict the flow of fluids, such as oil, water and/or gas, through the subterranean formation.

In step 102, a geomechanical model is constructed. Geomechanical modeling accounts for rock deformation due to pore pressure and temperature changes resulting from production and fluid injection. Furthermore, the geomechanical model simulates the rock deformation and failure in the modeled domain, including the overburden region, caprock, reservoir, and the underburden region.

In step 104, the reservoir simulation and the geomechanical models for performing a parametric simulation run are coupled together. Several methods for coupling the reservoir simulation and geomechanical models have been developed. For example, models can be one-way coupled, fully-coupled, or iteratively coupled. The total time of the operation of the simulated process is divided into a number of time steps. For the reservoir simulation-geomechanical one-way coupled model, for any given time step, one model solves its model equations first within the time step and generates the necessary information for the other model. The information generated is then used in the other model as input to solve the model equations to generate numerical simulation results of this model for the given time step. For the reservoir simulation-geomechanical fully-coupled model, the model equations for obtaining the numerical simulation results are simultaneously solved for a given time step. The reservoir simulation-geomechanical iteratively coupled model, solves the coupled model equations separately, but iteratively updates and exchanges the needed information from each other until a converged result is obtained for a given time step. For discussion purposes, the reservoir simulation-geomechanical one-way coupled model is utilized, however, other coupling processes can be used in practice.

For a given parametric case with a steam injection pressure, geological setting, and pad locations, the reservoir simulation model generates the pressure front and the temperature front as a function of time. The geomechanical model uses the pressure front and the temperature front as the input and also shares the same geological setting and the pad location as the reservoir simulation model to generate distributions of stress, strain, plastic strain, and displacement in the modeled regime that includes overburden, caprock, reservoir, and underburden.

In step 106, a plurality of parametric simulation runs are conducted using the coupled reservoir simulation-geomechanical model built in step 104. During this parametric study, each parametric simulation run corresponds to a specific set of numerical values of physical parameters. These physical parameters for the steam-assisted gravity drainage (SAGD) process, for example, include, but are not limited to: reservoir depth, reservoir thickness, steam injection pressure, steam injector depth, pressure and temperature fronts, geometric descriptions of geological settings, and pad locations. For other enhanced oil recovery processes, depending upon the governing physics, the set of selected physical parameters may be different from the set of parameters specified for the SAGD process.

In step 108, the equivalent plastic strain distribution in the caprock is calculated from the distribution of plastic strain tensor obtained in step 104 for each parametric simulation run. The equivalent plastic strain can be viewed as a measure to the potential of material failure. There are several definitions for equivalent plastic strain used in the literature. In this SAGD example, the equivalent plastic strain is defined as

$$\sqrt{\frac{2}{3} {ɛ}_{ij}^{p} {ɛ}_{ij}^{p}} ,$$

where εᵢⱼ^{p} is plastic strain tensor component ij which can be obtained from the plastic strain tensor.

In step 110, the maximum equivalent plastic strain value is determined. Based on the equivalent plastic strain distribution from step 108, the maximum equivalent plastic strain value in the caprock can be determined by searching the greatest value of equivalent plastic strain from all the values that consist of the equivalent plastic strain distribution in the caprock. The searching can be done by using a sorting algorithm, such as bubble sorting, that can sort a group of numbers in value ascending order (the last number is the maximum value) or in value descending order (the first number is the maximum number).

In step 112, the quantitative relationship of a zero caprock failure condition related to a correlation parameter, X, is determined. The correlation parameter, X, is in the form of a relationship of the physical parameters determined by step 106 and physical coefficients of the subterranean reservoir. The physical coefficients can be adjusted, as necessary. For a given set of fixed physical coefficients, the X value for each parametric simulation run studied can be calculated. Also, each parametric simulation run may be associated with a maximum equivalent plastic strain value as determined in step 110. Note, if the parametric simulation runs results in a maximum equivalent plastic strain of zero, then there is no failure in the caprock. By plotting the maximum equivalent plastic strain value on the vertical axis versus the correlation parameter, X, on the horizontal axis on a graph for the plurality of parametric simulation runs studied, the graph can be examined to identify a critical value on the horizontal axis that separates the plotted points into two groups. The critical value is an observed value between a grouping of plotted values with zero maximum equivalent plastic strain and a grouping of plotted values with a maximum equivalent plastic strain greater than zero. If a critical value cannot be found on the graph, then the values of physical coefficients in the relationship are adjusted. The X values for all parametric cases studied are recalculated with the new values of coefficients and make a new graphical depiction of maximum plastic strain versus X is once again plotted. The process is repeated until a critical value is observed that successfully separates the data points into two groups. Thus, the correlation parameter X is a function of the physical parameters with both the critical value and physical coefficients. If X is less than the critical value, then no caprock failure will occur.

The correlation parameter, X, is determined by utilizing the following relationship in conjunction with physical parameters and associated physical coefficients a, b, c:

$$X = {( \frac{{H}_{p}}{H} + \frac{{H}_{t}}{H} )}^{a} {( \frac{P}{{Z}_{3}} )}^{b} {( \frac{{D}_{1}}{H} )}^{c}$$

where H is the subterranean reservoir thickness; Hₚ is the height of the pressure front; Hₜ is the height of the temperature front; P is a steam injection pressure; Z₃ is the depth from the subterranean reservoir top; D₁ is the distance between the top of the subterranean reservoir and the center of the injection depth; and a, b, c are physical coefficients with characteristics of the field and a range of operating conditions. In an embodiment, H, Z₃, and Dᵢ can be estimated from well log data. In another embodiment, Hₚ and Hₜ can be estimated from the reservoir simulation model. In yet another embodiment, Hₚ and Hₜ can be estimated from field measurements by tracking the pressure and temperature fronts.

In step 114, the safe steam injection is determined by calculating the correlation parameter, X value for a given steam injection pressure, P, with the established quantitative relationship for X. If the X value obtained is less than the critical value, the given P value is a safe steam injection pressure. Otherwise, we decrease the P value until the P value selected yields an X value less than the critical value. This selected P value is a safe steam injection pressure.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method for determining the optimal safe injection operating pressure in a subterranean reservoir comprising:
a. constructing a reservoir simulation model;
b. constructing a geomechanical model;
c. coupling the reservoir simulation model and the geomechanical model;
d. conducting a plurality of parametric simulation runs utilizing the coupled reservoir simulation and geomechanical models;
e. calculating a maximum equivalent plastic strain for each parametric simulation run;
f. calculating a correlation parameter for each parametric simulation run, wherein the correlation parameter is a relationship between physical parameters of the subterranean reservoir, operating variables of the oil recovery process, and physical coefficients from subterranean reservoir characteristics;
g. plotting the maximum equivalent plastic strain versus the correlation parameter for each parametric simulation run;
h. evaluating the plot of the maximum equivalent plastic strain versus the correction parameter for the plurality of parametric simulation runs from step (g) to determine a critical value, wherein the critical value is an observed value between a grouping of plotted values with zero maximum equivalent plastic strain and a grouping of plotted values with a maximum equivalent plastic strain greater than zero;
i. adjusting the physical coefficients and repeating steps (e)-(h) until a critical value is determined;
j. re-calculating the correlation parameter of the subterranean formation for a given steam injection pressure; and
k. adjusting the given steam injection pressure until the re-calculated correlation parameter is less than the critical value.

2. A method for determining the optimal safe injection operating pressure in a subterranean reservoir comprising:
a. constructing a reservoir simulation model;
b. constructing a geomechanical model;
c. coupling the reservoir simulation model and the geomechanical model;
d. conducting a plurality of parametric simulation runs utilizing the coupled reservoir simulation and geomechanical models;
e. calculating a maximum equivalent plastic strain for each parametric simulation run;
f. calculating a correlation parameter for each parametric simulation run, wherein the correlation parameter is a relationship between physical parameters of the subterranean reservoir, operating variables of a steam assisted gravity drainage process, and physical coefficients from subterranean reservoir characteristics, wherein the correlation parameter is calculated by utilizing the following relationship
$${( \frac{{H}_{p}}{H} + \frac{{H}_{t}}{H} )}^{a} {( \frac{P}{{Z}_{3}} )}^{b} {( \frac{{D}_{1}}{H} )}^{c}$$
in which H=subterranean reservoir thickness,
Hₚ=the height of a pressure front,
Hₜ=the height of a temperature front,
P=a steam injection pressure,
Z₃=the depth from the top of the subterranean reservoir,
D₁=the distance between the top of the subterranean reservoir and the center of an injection depth, and
a, b, c=physical coefficients of the subterranean reservoir;
g. plotting the maximum equivalent plastic strain versus the correlation parameter for each parametric simulation run;
h. evaluating the plot of the maximum equivalent plastic strain versus the correction parameter for the plurality of parametric simulation runs from step (g) to determine a critical value, wherein the critical value is an observed value between a grouping of plotted values with zero maximum equivalent plastic strain and a grouping of plotted values with a maximum equivalent plastic strain greater than zero;
i. adjusting the physical coefficients of the subterranean reservoir and repeating steps (e)-(h) until a critical value is determined;
j. re-calculating the correlation parameter for a given steam injection pressure; and
k. adjusting the given steam injection pressure until the re-calculated correlation parameter is less than the critical value.
